(19) United States
(12) Patent Application Publication
(10) Pub. No.: US 2006/0098965 A1
(43) Pub. Date: May 11, 2006

(54) Lens-fitted photo film unit

(75) Inventors: Takeshi Masuda, Kanagawa (JP); Nobuyuki Kameyama, Minami-Ashigara-Shi (JP); Hirofumi Katsura, Minami-Ashigara-Shi (JP); Kazumi Koike, Minami-Ashigara-Shi (JP)

Correspondence Address: YOUNG & THOMPSON, 745 SOUTH 23RD STREET, 2ND FLOOR, ARLINGTON, VA, 22202, US

(73) Assignee: FUJI PHOTO FILM CO., LTD., MINAMI-ASHIGARA-SHI (JP)

(21) Appl. No.: 11/186,806

(22) Filed: Jul. 22, 2005

(30) Foreign Application Priority Data
Jul. 22, 2004 (JP) 2004-214753

(51) Int. Cl. G03B 17/02

(52) U.S. Cl. 396/6

(57) ABSTRACT

A lens-fitted photo film unit is not provided with a flash device. A photo film having ISO sensitivity of 1600 or above is preloaded in the lens-fitted photo film unit in a factory. An exposure device has a large-exposure amount mode and a small-exposure amount mode. In the large-exposure amount mode, appropriate exposure can be given to a subject when an exposure value at ISO 100 is less than 8. A mode switching operation member selects the large-exposure amount mode or the small-exposure amount mode.

### BACKGROUND OF THE INVENTION

1. Field of the Invention

The present invention relates to a lens-fitted photo film unit suitable for photographing a low brightness subject without using flash.

2. Description of the Prior Arts

Various lens-fitted photo film units in which a photo film is preloaded are well-known. For instance, there is a lens-fitted photo film unit with a built-in flash device capable of photographing in a dark room. Meanwhile, there is also a mode switch type of lens-fitted photo film unit capable of photographing a bright place such as outdoors in the day time and a dark place such as a dark room and outdoors in the night-time by selecting a photographic mode corresponding to the photographing condition. In the mode switch type of lens-fitted photo film unit, the backgrounds of the dark place photographs will be vividly described by using the photo film of high sensitivity.

In the lens-fitted photo film unit with the flash device, if a high-sensitive photo film of ISO 800 is used, the shutter speed is set to 1/140 seconds, and f-number is set to f10. In the lens-fitted photo film unit being set this way, when an exposure value is 10.8 at ISO 100, the appropriate exposure can be achieved. However, in the photography in the dark place, although a main subject in a relatively close range can be photographed with the appropriate exposure by emitting the flash, the background to which the flashlight does not reach is extremely underexposed due to insufficient light amount.

As the mode switch type of lens-fitted photo film unit in which the photo film of the high sensitivity is loaded, “Night and Day (commodity name)” produced by the applicant is well-known. This lens-fitted photo film unit is provided with a daylight mode (without emission of flash light), a daylight flash mode, and a night flash mode. The daylight flash mode is used for the portrait photographing under the back light condition for example, and prevents the face of the person from being darkened. In the night flash mode, the main subject such as a person is photographed with appropriate exposure by using the flash light while reproducing the background in a dark place with an appropriate density.

A small aperture/high-speed shutter state is used in the daylight mode and the daylight flash mode, while a large aperture/low-speed shutter state is used in the night flash mode. Specifically, when the photo film of ISO 1600 is used, the shutter speed is 1/120 second and the f-number is f14 for the daylight mode and the daylight flash mode, while the shutter speed is 1/45 second and the f-number is f6.2 for the night flash mode. In order to achieve the appropriate exposure, the exposure value (at ISO 100) in the daylight mode and the daylight flash mode is 10.5, and the exposure value in the night flash mode is 6.8.

In the night flash mode, the background in the night view, a dark room, or the like is reproduced with the appropriate density, while enough brightness for the main subject such as the person is secured by using the flash light. Therefore, there is a problem that the shading of the main subject is eliminated due to the flash light, and in addition, the obtained picture becomes planar by negating the light source color of the background, so that the impression of all the pictures becomes similar.

### SUMMARY OF THE INVENTION

An object of the present invention is to provide a lens-fitted photo film unit capable of photographing a main subject and the background in a dark place with well-balanced brightness and hue without using flash light.

In order to achieve the above and other objects, a lens-fitted photo film unit of the present invention includes a photo film whose ISO sensitivity is 1600 or above and an exposure device having a large-exposure amount mode and a small-exposure amount mode. In the large-exposure amount mode, appropriate exposure can be given to a subject when an exposure value based is less than 8 at ISO 100. The large or small-exposure mode is selected by a mode switching operation member.

In a preferred embodiment of the present invention, film sensitivity of the photo film is no less than ISO 3200. When a f-number in the large-exposure amount mode is f₀, the following condition is satisfied: f2.8≦f₀≦f8. When the focal length of a taking lens is L, the following condition is satisfied: L≦28 mm, preferably 17 mm≦L≦28 mm.

In another preferred embodiment of the present invention, the lens-fitted photo film unit includes a stop device and a mode switching operation member. The stop device can switch a stop opening between a small aperture state and a large aperture state. The mode switching operation member selects a first photographic mode which provides the small aperture state or a second photographic mode which provides the large aperture state. When the f-number in the small aperture state is f₁, and the f-number in the large aperture state is f₂, the following conditions are satisfied: f14≦f₁, f2.8≦f₂≦f8. The lens-fitted photo film unit further includes a shutter device for switching shutter speed between a high-speed shutter state in the first photographic mode and a low-speed shutter state in the second photographic mode. When the shutter speed in the high-speed shutter state is T₁, and the shutter speed in the low-speed shutter state is T₂, the following conditions are satisfied: 1/80 sec.≧T₁, 1/30 sec.≧T₂≧ 1/60 sec.

In further embodiment of the present invention, the lens-fitted photo film unit includes a stop device, a shutter device, and a mode switching operation member. The stop device can switch an aperture stop between a small aperture state a f-number is no less than f13, and a large aperture state in which the f-number is no more than f8. The shutter device can switch shutter speed between a high-speed shutter state in which the shutter speed is no more than 1/80 second and a low-speed shutter state in which the shutter speed is no more than 1/60 second. The mode switching operation member selects a first photographic mode which provides a small aperture/high-speed shutter state or a second photographic mode which provides a large aperture/low-speed shutter state.

According to the present invention, the photo film of ISO 1600 or above is loaded in the lens-fitted photo film unit with no flash device. The lens-fitted photo film unit is provided with the photographic mode in which the appropriate exposure value (at ISO 100) is less than 8. As a result, the photography in a dark place can be performed without using the flash light. In addition, it is possible to obtain pictures which give a sense of unity in brightness and hue of the background and the main subject by photographing under ambient light.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is an external perspective view of a lens-fitted photo film unit of the present invention which is set in a first photographic mode;

FIG. 2 is an external perspective view of the lens-fitted photo film unit which is set in a second photographic mode;

FIG. 3 is an exploded perspective view showing the lens-fitted photo film unit;

FIG. 4 is an exploded perspective view showing an aperture stop and a shutter device;

FIG. 5 is a plan view showing a shutter device in which a stop lever is in a high-speed shutter position;

FIG. 6 is an explanatory view showing the shutter device in which the stop lever is in a low-speed shutter position;

FIG. 7 is an explanatory view showing a stop device set in a small aperture state; and

FIG. 8 is an explanatory view showing the stop device set in a large aperture state.

### DETAILED DESCRIPTION OF THE PREFERRED EMBODIMENTS

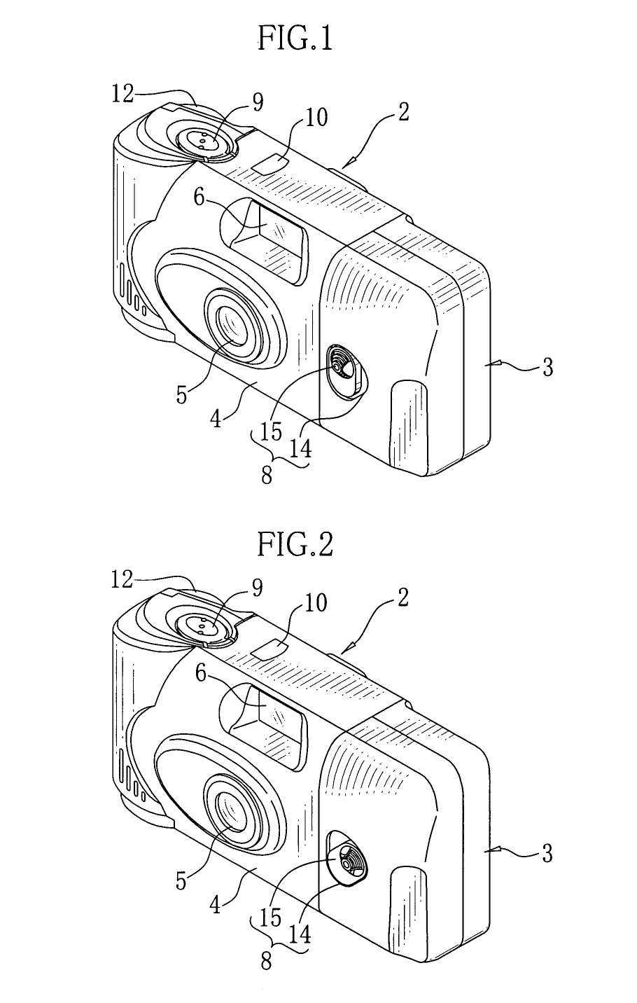

As shown FIG. 1, a lens-fitted photo film unit 2 is constituted of a unit body 3, a film cassette, and a sticker belt 4. The unit body 3 is provided with a photographing mechanism. The film cassette is loaded in the unit body 3 at the time of manufacturing in the factory. The sticker belt 4 is attached to an outside of the unit body 3. Openings are formed on the sticker belt 4 for uncovering respective portions of the unit body 3. The lens-fitted photo film unit 2 is not provided with a flash device including a light-emitting diode (LED) and so forth for irradiating auxiliary light toward the subject.

A front surface of the unit body 3 is provided with a taking lens 5, a viewfinder 6, and a photographic mode selection member 8. An upper surface of the unit body 3 is provided with a shutter release button 9 and a counter window 10. A winder wheel 12 for winding an exposed portion of the photo film partially appears in a rear surface of the unit body 3.

The photographic mode selection member 8 is constituted of a concave portion 14 and an operation member 15. The concave portion 14 is formed in the front surface of the unit body 3. The operation member 15 having an oval shape can rotate freely in the concave portion 14. The operation member 15 is movable between a first operating position shown in FIG. 1 and a second operating position shown in FIG. 2. The operation member 15 reaches the second operating position upon clockwise rotation from the first operating position.

In the lens-fitted photo film unit 2, when the operation member 15 is set in the first operating position, a first photographic mode (small-exposure amount mode) which provides a small aperture/high-speed shutter state is set. When the operation member 15 is set in the second operating position, a second photographic mode (large-exposure amount monde) which provides large aperture/low-speed state is set. Note that a predetermined mark or the like may be displayed in the viewfinder 6 so as to inform a user which of the photographic modes is set when the user observes the viewfinder 6.

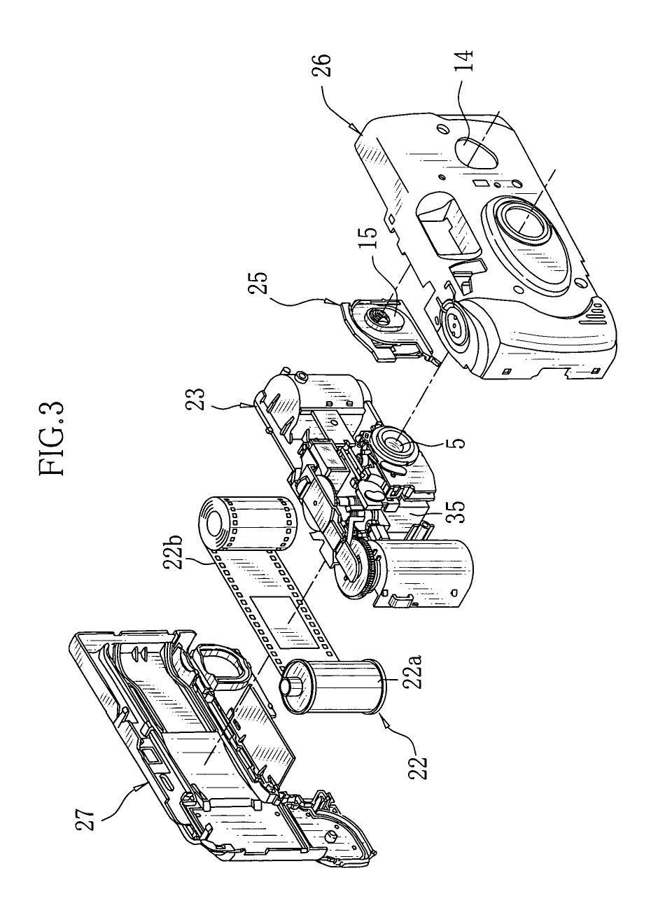

As shown in FIG. 3, the unit body 3 is constituted of a main body 23, a mode selector 25, a front cover 26 and a rear cover 27. The main body 23 is loaded with a 135 type photo film cassette 22. The mode selector 25 changes over the photographic modes. The front and rear covers 26 and 27 are respectively attached to the front and rear sides of the main body 23.

The photo film cassette 22 is constituted of a cassette 22a and a high-sensitive photo film 22b of ISU 1600 or above, which are loaded in the main body 23 at the time of manufacturing in the factory. In the present embodiment, a high-sensitive photo film of ISO 3200 is used as the photo film 22b.

A light-shielded tunnel 35 is provided in the center of the main body 23. Various elements are disposed on the periphery of the light-shielded tunnel 35, such as a shutter charging mechanism, a shutter device, a photo film winding mechanism, a photo film winding stopper mechanism, a frame counter mechanism, an stop device, a photographic optical system, a viewfinder optical system, and so forth.

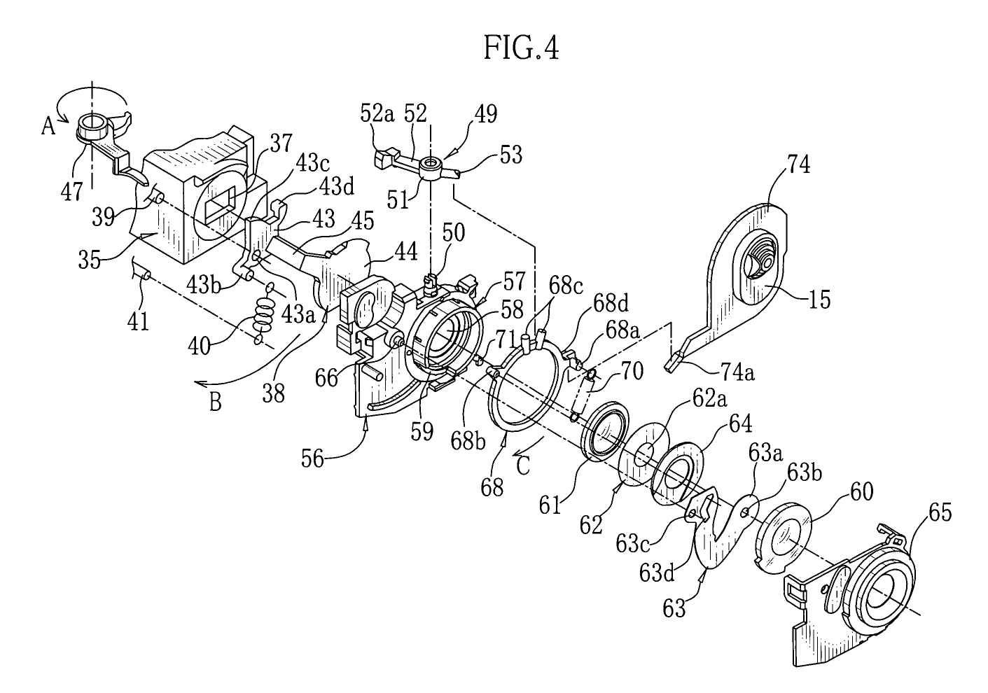

In FIG. 4, a rectangular exposure opening 37 is formed in the front surface of the light-shielded tunnel 35. A side of the light-shielded tunnel 35 is formed with a pin 39 for supporting a shutter blade 38 in a pivotable manner and a pin 41 on which one end of a spring 40 is retained.

The shutter blade 38 in the shutter device includes a base portion 43, a blade portion 44 and a coupling section 45. The base portion 43 has a hole 43a for receiving insertion of the pin 39. The bladeportion44 is disposed in front of the exposure opening 37 to open and close the exposure opening 37. The coupling section 45 connects the base portion 43 with the blade portion 44. The base portion 43 is provided with a pin 43b, a projection 43c and a shutter speed adjusting projection 43d. The other end of the spring 40 is retained on the pin 43b. The shutter blade 38 is biased by the spring 40 to be kept in a closed position to close the exposure opening 37.

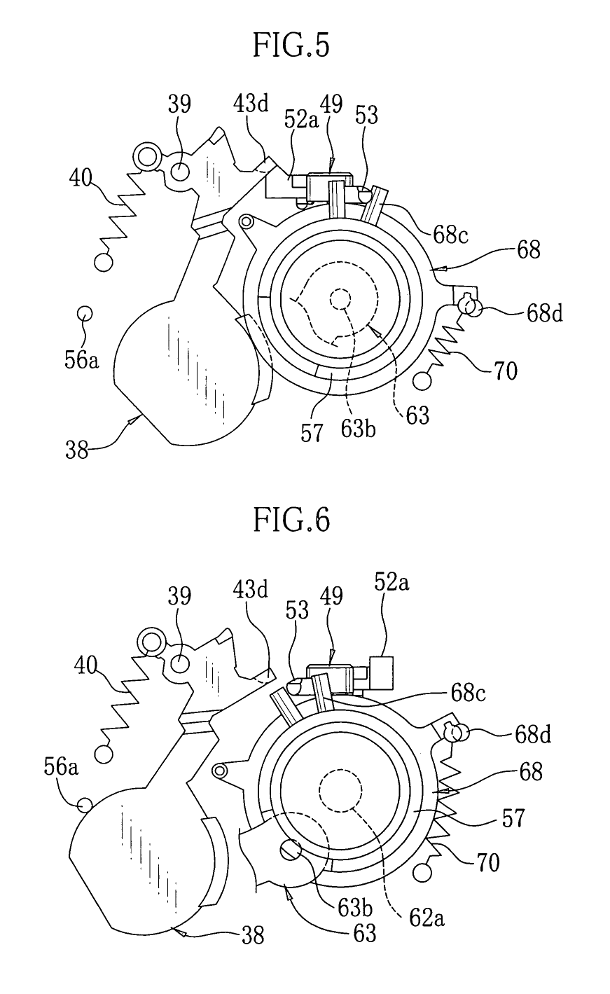

The shutter drive lever 47 is an element constituting the shutter device, and rotated in a direction opposite to the A direction by the shutter device to be set in a charged position. When the shutter drive lever 47 is released responding to the pressing operation of the shutter release button 9, it rotates in the A direction toward a released position, and knocks the projection 43c of the shutter blade 38 during the rotation. The shutter blade38 responsively rotates in the clockwise direction (B direction) against the bias of the spring 40 to open the exposure opening 37 fully. After that, the shutter blade 38 is caused by the bias of spring 40 to return to the closed position, and then closes the exposure opening 37 again. The shutter blade 38 is movable between the open position to open the exposure opening 37 fully and a moving end position where the shutter blade 38 is in contact with a stopper pin 56a (see FIGS. 5 and 6) provided in an inner surface of a lens holder 56.

The stop lever 49 constituting a shutter-speed changing mechanism of the shutter device is disposed on top of the lens holder 56, and supported by a pin 50 rotatably. The stop lever 49 is constituted of a boss 51 supported by the pin 50 and arms 52 and 53 projecting from the side surface of the boss 51. A pad 52a is formed on the end of the arm 52.

The stop lever 49 is rotated between a high-speed shutter position where the pad 52a is located in a moving track of the projection 43d and a low-shutter speed position where the pad 52a is located out of the moving track.

As shown in FIG. 5, when the shutter device is released while the stop lever 49 is in the high-speed shutter position, the projection 43d hits the pad 52a, so that rotation of the shutter blade 38 is blocked in the course of rotation toward the closed position. Therefore, the shutter blade 38 swings back to the closed position in a short time, and this makes the shutter speed high. The shutter speed in the high-speed shutter position is 1/100 second.

In contrast, as shown in FIG. 6, when the stop lever 49 is in the low-speed shutter position, the projection 43d rotates without hitting the pad 52a, so that the shutter blade 38 rotates to the moving end position. Therefore, time required for the return of the shutter blade 38 to return to the closed position is longer, to lower the shutter speed. The shutter speed in the low-speed shutter position is 1/45 second.

As shown in FIG. 4, the lens holder 56 is secured to the front side of the light-shielded tunnel 35. A cylindrical lens barrel 57 is formed on the center of the lens holder 56. An opening 58 (shutter opening) is formed in the lens barrel 57. A cutout 59 is formed in a lateral wall of the lens barrel 57. A first lens element 60 and a second lens element 61 constituting the taking lens 5 are contained in the lens barrel 57. A large stop plate 62 and a spacer 64 for securing an insertion space for a stop-changing plate 63 are provided between the first and second lens elements 60 and 61. A lens retention plate 65 is fixedly secured to the front of the lens holder 56 to retain the taking lens 5 and other relevant elements in the lens barrel 57. Also, a changeover ring 68 mounted on the periphery of the lens barrel 57 is retained by the lens retention plate 65.

The stop device is constituted of the large stop plate 62, the stop-changing plate 63, the spacer 64, the changeover ring 68, and so forth. The large stop plate 62 is made up of a circular plate with a small thickness. The center of the large stop plate 62 is formed with a large stop opening 62a. The large stop opening 62a is disposed on a photographing optical axis in the second photographic mode to establish the large aperture state. An aperture size of the large stop opening 62a is designed such that the f-number is f4.0.

The stop-changing plate 63 is an L-shaped plate with a small thickness. A small stop portion 63a at an end of the stop-changing plate 63 has a size to close the large stop opening 62a. A small stop opening 63b is formed in the small stop portion 63a. The small stop opening 63b is disposed on the photographing optical axis in the first photographic mode to establish the small aperture state. The aperture size of the small stop opening 63b is designed such that the f-number is f18. There are a hole 63c and a groove 63d in the other end portion of the stop-changing plate 63. A pin 66 provided in the vicinity of the lens barrel 57 is inserted in the hole 63c and keeps the stop-changing plate 63 pivotably.

The stop-changing plate 63 rotates between a small aperture position where the small stop opening 63b is disposed on the photographing optical axis and a large aperture position where the small stop portion 63a moves away from the lens barrel 57 through the cutout 59 to expose the large stop opening 62a. In the small aperture position, photographic light passes the large stop opening 62a and the small stop opening 63b, so that the light amount is limited by the small stop opening 63b having a smaller aperture size.

The changeover ring 68 is fitted to the outer periphery of the lens barrel 57 in a rotatable manner. The changeover ring 68 includes a spring-hang pin 68a, a link pin 68b, sandwich pins 68c and a follower pin 68d, which projects toward the rear side of the changeover ring 68. The spring-hang pin 68a is used to retain one end of a spring 70. The link pin 68b is inserted in the groove 63d of the stop-changing plate 63. The arm 53 of the stop lever 49 is disposed between the sandwich pins 68c.

A pin 71 projects from a lower portion of the front surface of the lens holder 56, and retains the other end of the spring 70, which biases the changeover ring 68 in the clockwise direction (C direction). The changeover ring 68 is kept in a predetermined position by the stop-changing plate 63. An actuate plate 74 is integrally formed with the operation member 15. A pressing lever 74a projects from the actuate plate 74 toward a horizontal direction.

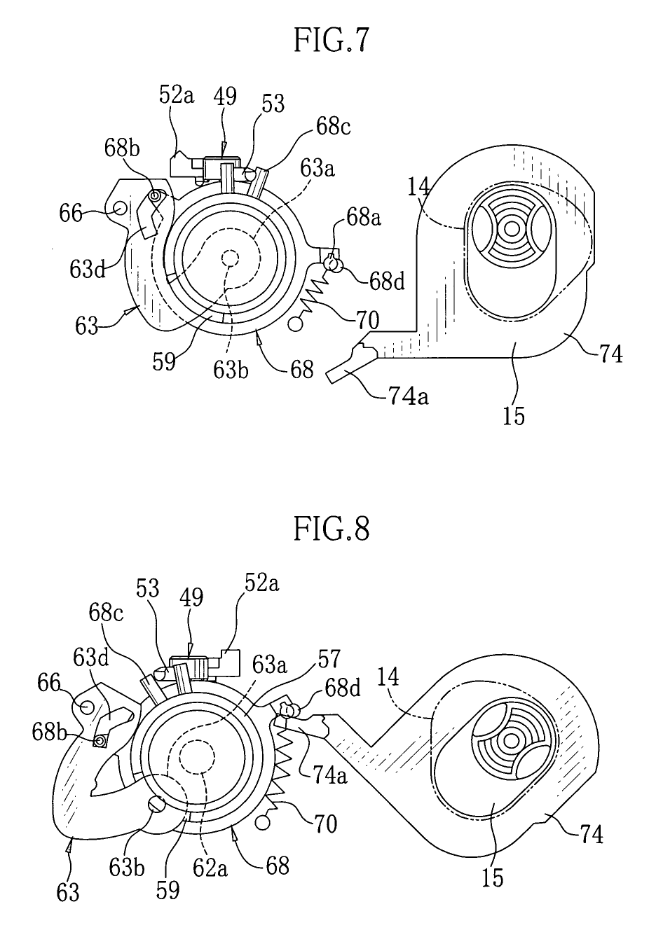

As shown in FIG. 7, when the operation member 15 is in the first operating position, the pressing lever 74a does not contact with the follower pin 68d. Therefore, the changeover ring 68 is kept in an initial position in connection with the stop-changing plate 63.

When the changeover ring 68 is in the initial position, the small stop portion 63a is inserted in the lens barrel 57 by the link pin 68b, so that the small stop opening 63b is overlaid on the large stop opening 62a to establish the small aperture state. Note that the sandwich pins 68c keep the stop lever 49 in the high-speed shutter position.

As shown in FIG. 8, when the operation member 15 moves from the first operating position to the second operating position, the pressing lever 74a pushes up the follower pin 68d against the biasing of the spring 70, and causes the changeover ring 68 to rotate in the counterclockwise direction. In response, the stop-changing plate 63 pressed by the link pin 68b rotates in the clockwise direction. The small stop portion 63aseparates from the optical axis to establish the large aperture state. Note that the sandwich pins 68c keep the stop lever 49 in the low-speed shutter position.

In the first photographic mode, the appropriate exposure value based is 10 at ISO 100. When excess or deficiency of exposure amounts from +5.5 EV (overexposure) to −1.5 EV (underexposure) is permitted in view of the latitude of the color negative photo film 22b, the photographing can be performed within the range of EV8.5-EV15.5. In the second photographic mode, the appropriate exposure value based is 4.5 at ISO 100. The photographing can be performed within the range of EV3.0-EV10.0 in view of the latitude of the color negative photo film 22b. Therefore, it is possible to photograph in the dark places without emitting the flash light. Note that the appropriate exposure value at ISO 100 can be obtained by the following equation when the f-number is f, the shutter speed is T (second), and the film sensitivity is S:
EV=log₂(f²/T)−log₂(S/100).

In the second photographic mode enabling the photographing in the dark places without emitting the flash light, when the photo film of ISO 1600 or above is used, the appropriate exposure value at ISO 100 is preferably less than 8. In addition, the film sensitivity is preferably ISO 3200 or above. Moreover, the f-number in the second photographic mode is preferably no less than f2.8 and no more than f8, and the shutter speed is preferably no less than 1/60 second (low speed).

With respect to the focal length of the taking lens 5, it is preferable to ensure appropriate depth of photographic filed even in the large aperture state by providing the taking lens 5 a wider field angle in view of the substantial matching range of focusing. When the f-number is no less than f2.8 and no more than f8 in the large aperture state, the focal length of the taking lens 5 is no more than 28 mm, preferably no less than 17 mm and no more than 28 mm.

In the above embodiment, the focal length of the taking lens 5 is 26 mm, and the f-number in the second photographic mode is f4.0. The taking lens 5 is constituted such that a photographic subject at the distance of 2 m is brought into focus. Thus, the subject at the distance from 1 m to infinity is brought into focus in the first photographic mode, while the subject at the distance of 1 m-3 m is brought into focus in the second photographic mode.

The f-number is preferably no less than f13 in the first photographic mode for the photographing at the bright places. The photographing in the bright places may be performed only by changing the aperture stop without changing the shutter speed; however, the shutter speed is preferably changed together with the aperture stop. The shutter speed in the first photographic mode is preferably no more than 1/80 second (high speed).

Next, the operation of the above embodiment is explained. In the photographing in the bright places, the first photographic mode is selected by setting the operation member 15 in the first operating position as shown in FIG. 1.

When the operation member 15 rotates to the first operating position, the changeover ring 68 is rotated to the initial position by biasing of the spring 70 as shown in FIG. 7. Thereby, the stop-changing plate 63 is set in the small aperture position, while the stop lever 49 is kept in the high-speed shutter position.

In FIG. 5, when the release button 9 is pressed in the first photographic mode, the shutter blade 38 rotates from the closed position to the open position, and then returns to the closed position again, so as to open and close the exposure opening 37. Since the stop lever 49 is kept in the high-speed shutter position, the projection 43d hits the pad 52a and the shutter blade 38 returns to the closed position before reaching the moving end position. Thereby, the exposure is performed at the shutter speed of 1/100 second.

While the exposure opening 37 is opened and closed in accordance with the rotation of the shutter blade 38, the light from the subject which has entered the taking lens 5 is exposed to the photo film 22b through the small and large stop openings 63b and 62a. The exposure amount is limited by the small stop opening 63b whose f-number is f18.

As a result, the exposure is performed to the photo film 22b having the film sensitivity of ISO 3200 under the condition that the shutter speed is 1/100 second and the f-number is f18. The appropriate exposure value is 10 in the first photographic mode, and the favorable photographing can be performed within the range of EV8.5-EV15.5.

When photographing a dark subject such as the night view or a main subject in a dark place, the operation member 15 is rotated from the first operating position to the second operating position, and the second photographic mode is selected, as shown in FIG. 2.

As shown in FIG. 8, when the operation member 15 rotates to the second operating position, the follower pin 68d of the changeover ring 68 is pushed up by the pressing lever 74a of the actuate plate 74. Thereby, the changeover ring 68 rotates in the counter clockwise direction from the initial position against the biasing of the spring 70. In response, the stop-changing plate 63 rotates to the large aperture position to separate the small stop opening 63b from the optical axis of the taking lens 5, so that the light amount is limited by the large stop opening 62a. The stop lever 49 is kept in the low-speed shutter position.

When the photographing is performed by pressing the release button 9 in the second photographic mode, the stop lever 49 is in the low-speed shutter position, so that the shutter blade 38 rotates without hitting the pad 52a, and returns to the closed position after reaching the moving end position. The light from the subject which has entered the taking lens 5 exposes the photo film 22b after passing only through the large stop opening 62a.

When the photo film 22b having the film sensitivity of ISO 3200 is exposed, the shutter speed is 1/45 second and the f-number is f4.0. When the appropriate exposure value is 4.5 in the second photographic mode, the favorable photographing can be performed within the range of EV3.0-EV10.0. In this case, since the flash is not emitted, it is possible to perform the photographing with utilizing the available light such as an illumination light source in a room. As a result, it is possible to obtain the image having a sense of unity in the brightness and the hue of the main subject and the background. Moreover, since the flash light is not used in the present embodiment, it is advantageous in terms of preventing the occurrence of red eye phenomenon and the shadow caused by the flash light. Furthermore, the flash device is not provided in the unit body, so that a battery and other parts for the flash device can be reduced, and thereby the weight of the lens-fitted photo film unit can be also reduced.

In the above embodiment, although the lens-fitted photo film in which the first and second photographic modes are switched is explained, the present invention is applicable to the lens-fitted photo film with only the second photographic mode.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A lens-fitted photo film unit without a flash device comprising:
a photo film, preloaded in a factory, having ISO sensitivity of 1600 or above; and
an exposure control device having a large-exposure amount mode and a small-exposure amount mode, and being capable of giving appropriate exposure to a subject when an exposure value at ISO sensitivity of 100 is less than 8 in said large-exposure amount mode.

2. A lens-fitted photo film unit as claimed in claim 1, further comprising a mode switching member for selecting one of said large-exposure amount mode and said small-exposure amount mode.

3. A lens-fitted photo film unit as claimed in claim 2, wherein film sensitivity of said photo film is no less than ISO 3200.

4. A lens-fitted photo film unit as claimed in claim 3, wherein the following condition is satisfied:
f2.8≦f₀<f8
where f-number in said large-exposure amount mode is f₀.

5. A lens-fitted photo film unit as claimed in claim 4, wherein the following condition is satisfied:
L≦28 mm
where focal length of a taking lens is L.

6. A lens-fitted photo film unit as claimed in claim 5, wherein the following condition is satisfied:
17 mm≦L≦28 mm

7. A lens-fitted photo film unit without a flash device comprising:
a photo film, preloaded in a factory, having ISO sensitivity of 1600 or above;
a stop device having a small aperture state and a large aperture state; and
a mode switching operation member for selecting one of a first photographic mode which establishes said small aperture state and a second photographic mode which establishes said large aperture state, appropriate exposure value at ISO sensitivity of 100 being less than 8 in said second photographic mode.

8. A lens-fitted photo film unit as claimed in claim 7, wherein film sensitivity of said photo film is no less than ISO 3200.

9. A lens-fitted photo film unit as claimed in claim 8, wherein the following conditions are satisfied:
f13≦f₁, and f2.8≦f₂≦f8
where f-number in said small aperture state is f₁, and f-number in said large aperture state is f₂.

10. A lens-fitted photo film unit as claimed in claim 9, further comprising: a shutter device for setting shutter speed to a high-speed shutter state in said first photographic mode, and setting the shutter speed to a low-speed shutter state in said second photographic mode.

11. A lens-fitted photo film unit as claimed in claim 10, wherein the following conditions are satisfied:
1/80 sec.≧T₁, and 1/30 sec.≧T₂≧ 1/60 sec.
where the shutter speed in said high-speed shutter state is T₁, and the shutter speed in said low-speed shutter state is T₂.

12. A lens-fitted photo film unit without a flash device comprising:
a photo film, preloaded in a factory, having ISO sensitivity of 1600 or above;
a stop device having a small aperture state in which f-number is no less than f13 and a large aperture state in which the f-number is no more than f8;
a shutter device having a high-speed shutter state in which shutter speed is no more than 1/80 second and a low-speed shutter state in which the shutter speed is no less than 1/60 second; and
a mode switching operation member for selecting one of a first photographic mode and a second photographic mode, said first photographic mode establishes said small aperture/high-speed shutter state, said second photographic mode establishes said large aperture/low-speed shutter state.
